(19) United States
(12) Patent Application Publication
(10) Pub. No.: US 2008/0224537 A1
(43) Pub. Date: Sep. 18, 2008

(54) Motor Vehicle Supply System Featuring Battery-Independent Buffering of the Generator Current

(75) Inventor: Gunter Uhl, Helmstadt-Bargen (DE)

Correspondence Address: BOYLE FREDRICKSON S.C., 840 North Plankinton Avenue, MILWAUKEE, WI, 53203, US

(73) Assignee: Catem Develec GmbH, Herxheim (DE)

(21) Appl. No.: 10/597,911

(22) PCT Filed: Feb. 2, 2005
(86) PCT No.: PCT/EP2005/001044

§ 371 Date: Apr. 22, 2008

(30) Foreign Application Priority Data
Feb. 16, 2004 (EP) 04003414.2

(51) Int. Cl. H02J 7/34

(52) U.S. Cl. 307/10.1

(57) ABSTRACT

The present invention relates to a motor vehicle electrical system, comprising a generator, a battery, a high-capacity capacitor and a power distributor for controllably supplying energy to individual load circuits of the motor vehicle. The generator, the battery and the high-capacity capacitor are connected in parallel. The electrical connection line between the battery and the power distributor has a cross-section of less than 10 mm² if the line is less than 2 m long while having a cross-section of less than 40 mm² if the line is more than 2 m long.

### BACKGROUND OF THE INVENTION

1. Field of the Invention

The invention relates to an improved motor vehicle electrical system. The invention particularly relates to a novel motor vehicle electrical system in which the conventional battery functions are non-interacting.

2. Description of the Related Art

A motor vehicle electrical system supplies a plurality of control devices and signal components in a motor vehicle with power. The power is taken either from a battery as energy storage or from a generator when the motor vehicle engine is in operation. A plurality of individual applications can be supplied with power from the motor vehicle electrical system by means of relays or an electronic power distributor with semiconductor switches via individual load circuits.

Conventional electrical systems having a voltage of 14 V are based on a battery voltage of 12 V. Future electrical systems are provided with a 36 V battery. For a transition time during which a changeover from a 14 volt to a 42 volt system takes place, both systems in a motor vehicle are used in parallel.

A schematic illustration of a conventionally designed motor vehicle electrical system is shown in FIG. 1. In the electrical system 100 as illustrated a generator 120, a battery 150 and a starter 110 are connected in parallel. In general, the line length 130 between the generator 120 and the starter 110, on the one hand, and the battery 150, on the other hand, each amounts to approximately 1 m. The starter and the generator are mounted at the engine block and are connected to each other by a short cable. Owing to fluctuations in the current supplied by the generator, and for the transmission of the starter current, the line cross-section amounts to approximately 25 mm².

The power is supplied to different load circuits 160 in the electrical system of the motor vehicle by a conventional power distribution point or power distributor 140. Each load circuit 160 supplies one or more consumers with power. With a line length of a load circuit of approximately 1 m these lines may have a smaller cross-section than line 130, namely of approximately 5 mm².

While the starter 110 has a very high power consumption of up to 300 A, for short periods even up to 600 A, the power consumption of all other consumers in the motor vehicle electrical system is significantly lower. Typical current values of consumers in the motor vehicle electrical system range from approximately 1.5 A when all lamps are used as parking lights, 3 A for the stop light and flasher, 8 A for the windscreen wiper and 8.5 A for fog lamps and main headlamps, via 10 A for dimmed headlight and the passenger compartment fan of an air-conditioning system, 18 A for the engine control with a fuel pump and 20 A for the seat heating, to an electric PTC-heater having a power consumption in the range of approximately 100 A.

All load circuits 160 are protected against a short circuit by means of an overcurrent protector so that the power supply to the respective load circuit is interrupted as soon as a short circuit occurs. By this, a thermal overheating of the cable and plug connectors in the respective load circuit is prevented.

### OBJECT OF THE INVENTION

It is the object of the invention to provide an improved motor vehicle electrical system.

This object is achieved with the features of claim 1.

According to the invention a motor vehicle electrical system is provided, comprising a generator, a battery, a high-capacity capacitor and a power distributor for controllably supplying energy to load circuits of the motor vehicle. The generator, the battery and the high-capacity capacitor are connected in parallel. The electrical connection line between the battery and the power distributor has a cross-section of less than 10 mm² if the line is less than 2 m long while having a cross-section of less than 40 mm² if the line is more than 2 m long.

It is the particular approach of the present invention to effect a smoothing of voltage fluctuations of the current supplied by the generator not by the battery, as conventionally, but by the high-capacity capacitor. Therefore, the battery needs no longer be mounted between the generator and the consumers of the electrical system. Moreover, the energy for the starting process is no longer supplied by the battery, but by the high-capacity capacitor. No more high currents are flowing in the connection line between the battery and the power distributor, so that smaller line cross-sections are possible. An electrical connection line between the battery and the power distributor therefore no longer has to cope with large currents and can be realized with significantly smaller line cross-sections. While conventionally line cross-sections of 25 mm² are used if the battery is mounted in the engine compartment, and of 95 mm² if the battery is mounted in the rear end, according to the invention cross-sections of less than 10 mm² can be used if the battery is mounted in the engine compartment, and of less than 40 mm² if the battery is mounted in the rear end of the motor vehicle. Thus, motor vehicle electrical systems can be realized with a smaller weight and at lower expenditures.

The high-capacity capacitor is preferably disposed in the power distributor. Thus, only the electrical connections between the generator and the capacitor or the starter and the capacitor, respectively, have to be designed for a higher current loading while the arrangement of the battery in the motor vehicle is freed from the previous restrictions of today's electrical systems and can be mounted anywhere.

The electrical connection line between the generator and the power distributor preferably has a cross-section of less than 10 mm², more preferably of approximately 5 mm².

The connection line between the battery and the power distributor preferably has a maximum cross-section of approximately 5 mm² if the line is maximally 2 m, preferably 1 m, long. These line lengths allow the mounting of the battery in the engine compartment of the motor vehicle with the use of a particularly small line cross-section.

According to another embodiment of the present invention the line between the power distributor and the battery is maximally 4 m long, with a maximum line cross-section of approximately 25 mm². This line length allows the mounting of the battery anywhere in the vehicle, especially in the rear end, whereby—as compared to a conventional line cross-section of approximately 95 mm²—only a maximum line cross-section of approximately 25 mm² is required.

Further advantageous embodiments are the subject matter of the dependent claims.

### BRIEF DESCRIPTION OF THE DRAWINGS

The present invention will be explained by means of preferred embodiments in connection with the attached drawings below. In the drawings:

FIG. 1 shows the configuration of a conventional motor vehicle electrical system;

FIG. 2 shows the configuration of an inventive motor vehicle electrical system;

FIG. 3 shows a detailed configuration of an inventive motor vehicle electrical system according to the present invention; and

FIG. 4 shows an electrical equivalent circuit diagram for a conventional car battery.

### DETAILED DESCRIPTION OF THE PREFERRED EMBODIMENTS

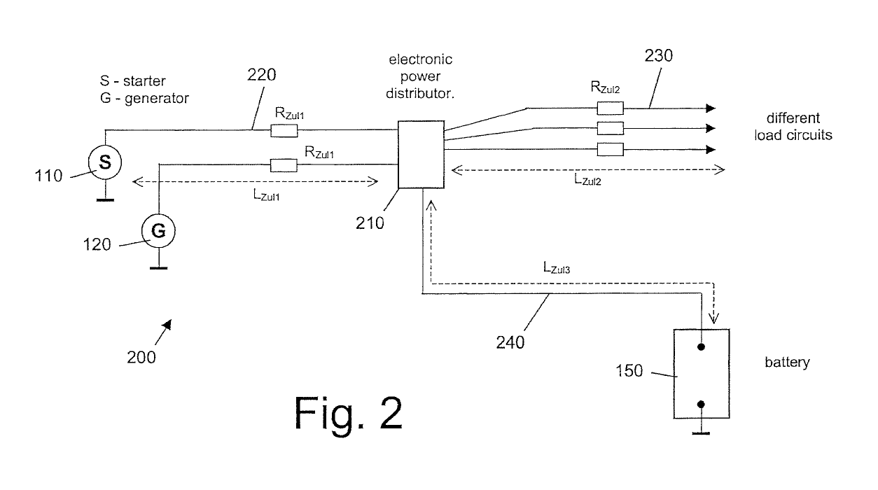

FIG. 2 schematically shows the configuration of an inventive motor vehicle electrical system. A starter 110 and a generator 120 are connected to an electronic power distributor 210 by separate supply lines 120. Likewise connected to the electronic power distributor is a battery 150 via a supply line 240. While the generator 120 provides electric current to the motor vehicle electrical system 200 during the operation of the motor vehicle engine, the battery 150 stores during the operation of the engine the energy provided by the generator 120. To activate the engine electric energy is generated by a chemical reaction in the battery 150 and supplied to the starter 110.

The power distributor 210 controllably connects individual load circuits 230 to the motor vehicle electrical system.

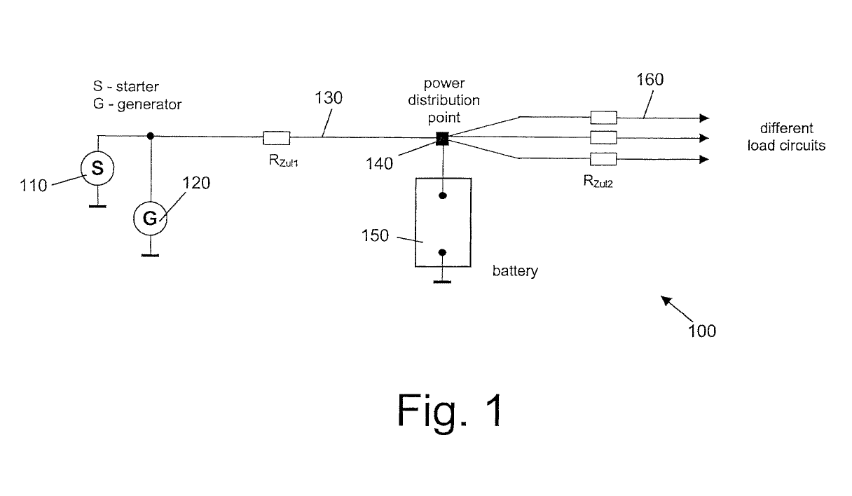

Other than with conventional motor vehicle electrical systems 100, the battery 150 in the inventive electrical system 200 can be positioned anywhere in the motor vehicle without having to use line connections with large line cross-sections. While a supply line 130 in a conventional electrical system 100 according to FIG. 1, the length L_{Zul1} of which is approximately 1 m, has a cross-section of 25 mm², the supply lines 220 according to the invention, the length of which is the same, only have a cross-sectional area of approximately 5 mm². The load circuits starting out from the power distribution point have a cross-section of 5 mm² with a length L_{Zul2} of approximately 1 m.

If the battery 150 is mounted in the proximity of the power distribution point 140 in the engine compartment, also the electrical connection of the battery with the power distribution point has a cross-section of approximately 5 mm² with a length L_{Zul3} of approximately 1 m as a maximum.

Alternatively, the battery with the power distribution point is mounted in the rear end of the motor vehicle. With this arrangement, all connecting lines to and from the power distribution point 140 or the battery 150, respectively, are considerably longer in a conventional electrical system 100. At the same time, the line cross-sections have to be increased in order to avoid, in view of a greater line length with a correspondingly higher resistance, a thermal development in the lines. For this reason, the cross-section of lines 130, having a length L_{Zul1}, conventionally increases from approximately 4 m to approximately 95 mm² and the line cross-section of the lines of the load circuits 160, having a length L_{Zul2}, from approximately 5 m to approximately 25 mm².

According to the invention these cross-sections can be reduced considerably. For this purpose, the electronic power distributor 210 and the battery 150 are arranged to be physically separated from each other. At the same time, the buffer function performed by a conventional battery for the compensation of voltage fluctuations of the generator 120 is shifted into the electronic power distributor 210. With this arrangement all lines having a maximum length of approximately 1 m may have a cross-section in the order of magnitude of 5 mm². Only if the battery 150 is mounted in the rear end of a motor vehicle, with the electronic power distributor 210 remaining in the engine compartment of the motor vehicle, is a longer line connection between the electronic power distributor 210 and the battery 150 required. Up to a length L_{Zul3} of approximately 4 m the line cross-section is approximately 25 mm².

In dependence on the respective application a further reduction of the line cross-sections is, according to the invention, possible by performing an active current monitoring for controlling the protection behavior in the power distributor 210. The active monitoring of the current flowing into a load circuit 230 allows, with a specified time response, especially with a fast increase over a predetermined value, to switch off the load circuit.

Contrary to this, the cross-section of conventional lines is usually designed for double the nominal current in order to be able to cope with short current peaks in the load circuit without any thermal overload of the lines. The inventive current monitoring by means of a microprocessor-controlled control unit allows to adapt the overload protection to short overload peaks and the short circuit behavior more exactly. By this, the cross-section and thus the weight and the costs of the motor vehicle electrical system can be reduced in a simple manner.

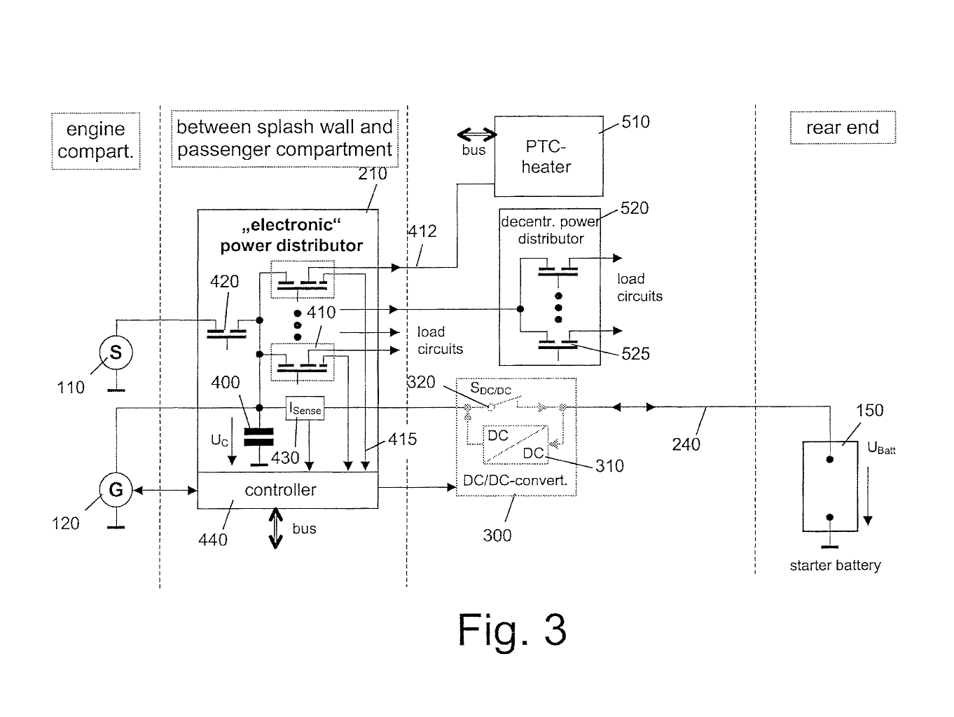

Additional details of the inventive electrical system are illustrated in FIG. 3. In the embodiment shown in FIG. 3 the battery 150 is preferably mounted in the rear end of the vehicle.

The electronic power distributor 210 comprises a plurality of semiconductor switches 410 which controllably connect the individual load circuits 412 to the motor vehicle electrical system, i.e. activate or interrupt a power supply to the individual load circuits. For such semiconductor switches especially semiconductor switches with a smart power control are used. Such a semiconductor switch, e.g. component 98 0268 of the company “International I.R. Rectifier”, measures the current flowing into the connected load circuit. A current proportional to the measured current is outputted via a separate terminal of the aforementioned semiconductor component. The current measured by each semiconductor switch 410 is supplied to a controller 440 of the electronic power distributor 210. This controller arranged either inside the electronic power distributor 210 or separately therefrom individually monitors the permissible current for each load circuit.

The current value permissible for each load circuit is preferably separately adjustable in the controller 440 for each load circuit 412. According to a preferred embodiment different current levels and different “trigger” characteristics are provided in the controller 440, which can be selected separately for each load circuit 412. As soon as the current measured for a load circuit 412 exceeds the maximum value determined for the same, by taking into account a permissible overload current, the controller 440 causes the semiconductor switch 410 to interrupt the electrical connection.

Such a semiconductor switch allows a reversible switch-off operation, in which the load circuit can be put back into operation without the exchange, for example, of a safety fuse. The active current monitoring moreover allows a fast reaction in the event of a short circuit. Very high short circuit currents therefore only flow for a few milliseconds. Thus, the lines and connectors of the respective load circuit need not be designed for a short circuit event, during which a high current flows for a clearly longer time.

The “intelligent” monitoring of the respective load circuit in the controller 440 allows the permission of short overcurrents without an interruption of the electrical connection for power supply to the load circuit. The response characteristic can thus be designed on an individual basis. It can especially be adapted to the function and the current demand (and short-term overcurrent demand) of the respective load circuit, whereby short overcurrents when starting an engine or switching on lights, heaters etc. have to be considered.

The protective function is to prevent that overcurrents or short circuits, respectively, occur in the load circuits and entail a thermal overload of the lines and connectors. The thermal overload is caused by the converted energy, i.e. current level multiplied by the time during which the overcurrent is present. It may by all means be permissible to let ten times the nominal current flow into a load circuit for one second without the occurrence of a damage. Such an overcurrent has to be recognized by the controller 440 as unproblematic, while a safety fuse would, in the event of such an overcurrent, result in an interruption and break the circuit irreversibly (until the fuse is exchanged).

Short-term overcurrents having a multiple value of the nominal current occur, for example, when an electromotor is started. When starting an electromotor the rotor may initially be somewhat heavy or jammed, especially at low ambient temperatures. An overcurrent corresponding to a multiple of the nominal current occurs for some 100 ms. Also with electrical PTC-heaters, which are used for heating the air blown into the passenger compartment of a motor vehicle, currents can occur during the start-up within a time interval of approximately 10 seconds, which correspond to double the nominal current. Due to the extremely short occurrence of such overcurrents, these are unproblematic with respect to the lines and the connectors.

A conventional safety fuse is, as a rule, adopted to a response current which is larger than double the nominal current. Such a conventional fuse would, however, also accept a lasting overcurrent corresponding to 1.8 times the nominal current. Contrary to this, an electronic fuse protection according to the present invention can detect such an overcurrent and interrupt the electrical connection when the time criterion is exceeded, e.g. 10 seconds. The dimensioning of the respective load circuit can, therefore, be designed for the actual nominal current, so that the line cross-sections and the connector need not withstand double the nominal current for a long time.

The controller 440 according to the invention can also be adapted to the current ambient temperature by means of an additional temperature sensor. At low ambient temperatures, higher currents can be permitted due to the improved cooling. The overcurrent detection and disconnection of a load circuit is therefore preferably effected in dependence on the temperature, namely, according to a preferred embodiment, on the basis of a predetermined dependence between the upper limit of the current to be applied and the detected ambient temperature.

According to another advantageous embodiment the controller can disconnect a load circuit 412 also in response to an external signal. Troubles in a consumer of a load circuit can, for example, be detected by separate sensors, and the danger for the motor vehicle emanating from said troubles can be banned prematurely.

FIG. 3 shows, as examples only, a PTC-heater 510 and a decentralized power distributor 520 as consumers. The decentralized power distributor 520 can likewise connect and disconnect subordinate load circuits by a plurality of semiconductor switches 525. These load circuits are only examples. The person skilled in the art will appreciate that each electrical consumer of a motor vehicle can be controlled directly by such a load circuit 412, or indirectly by a decentralized power distributor 520.

According to the invention a high-capacity capacitor 400 is provided in the electric power distributor 510, which is connected in parallel with respect to the generator 120 and the battery 150. The capacitor 400 has high capacity values with a small construction volume. For a motor vehicle, preferably, capacities in the range of 450 to 600 F are used. Nowadays, double-layer capacitors may even reach capacities of up to several thousand F.

As compared to aluminum electrolyte capacitors double-layer capacitors reach an energy density which is multiple times higher, and a power density which is many times higher than that of lead-acid batteries. While the electric energy in batteries is stored electrochemically, the electric energy in a capacitor is stored directly in the form of positive or negative charges on the plates of the capacitor, and no chemical reaction on the electrode surfaces is required. Such double-layer capacitors, e.g. double-layer capacitors of the company EPCOS with the designation “UltraCap”, store electric energy and release it again with high efficiency. In contrast to batteries they can be charged and discharged with very high currents in a wear-free manner. Moreover, they allow a reliable function also at very low temperatures and low voltage values. They release high powers without delay and at very low losses with discharge currents of up to 400 A.

Due to the parallel connection of a high-capacity capacitor 400 with respect to the generator 120 and the starter battery 51 several advantages can be achieved. The starting process is no longer within the responsibility of the battery 150, but of the high-performance capacitor 400. The capacitor 400 is charged by the battery 150 prior to the starting process. Next, the capacitor 400 releases the stored energy to the starter 110. The starting process can thus be realized in a more reliable manner, as the capacitor is able to release high amounts of energy also for short times at low temperatures. Contrary to this, conventional motor vehicles frequently have starting problems at low temperatures as the chemical reactions taking place in the battery 150 do not permit high currents.

According to a particularly advantageous embodiment of the invention the starting behavior can be improved further by increasing the energy stored in the capacitor without an increase of the capacity of the same. To this end, a voltage transformer 310 is inventively connected between the battery 150 and the capacitor 400 to prepare a starting process. The voltage transformer 310 transforms the voltage supplied by the battery 150 into a higher voltage. Thus, with the same capacity, the capacitor is able to absorb a much larger amount of energy. The amount of energy stored in the capacitor can be determined in accordance with the following equation:

E=½·C·U².

At the same time, an interrupter 320 is connected into the electrical connection between the battery 150 and the capacitor 400, parallel to the voltage transformer 310. The interrupter breaks the direct electrical connection between the battery and the capacitor, so that a very much higher voltage can be supplied to the capacitor.

The device 300 according to the invention, comprising a voltage transformer and an interrupter, permits a significant increase of the energy available for a starting process in a simple manner. A reliable start of the motor vehicle is then still feasible, even with a low battery having only small energy reserves left.

A starting process, for which the voltage transformer according to the invention is used, is described by means of an example below.

During the rest period of the motor vehicle, i.e. the engine and the ignition are switched off, the voltage transformer (DC/DC converter) 310 is switched off, and the electrical connection between the electrical power distributor 210 and the battery 150 is generated by switch 320. Thus, the capacitor 400 is connected in parallel to the battery 150 and is charged to the battery voltage U_{BATT}; in conventional electrical systems to a voltage of approximately 12.5 V, in future electrical systems to approximately 42 V.

Prior to the starting process of the internal combustion engine the voltage transformer 310 is activated, and switch 320 is opened simultaneously. If required, individual load circuits are preferably disconnected by the electronic power distributor 210. Especially those load circuits 412 are disconnected, which have a large power demand. According to a specific embodiment the disconnection can be accomplished by the controller 440 also in dependence on the level of the battery voltage, so as to ensure a reliable start if the battery is low.

The voltage transformer now generates an output voltage which is applied to the capacitor, wherein the output voltage is above the battery voltage. With a battery voltage of 12.5 V the increased output voltage is, for example, 16 V. Thus, the voltage is above the battery voltage by 3.5 V and charges the capacitor correspondingly higher. Thus, also the energy stored in the capacitor is higher by approximately 60% as compared to a conventional charging voltage of 12.5 V.

By this, sufficient energy reserves are available for the starting process even if the battery is low with a battery voltage lower than 12.5 V. If the voltage transformer always charges the capacitor 400 with a voltage of 16 V, always the same amount of energy is available for the starting process, irrespective of the performance of the battery.

The advantage achieved with the voltage transformer can either be converted into increased energy reserves for the starting process or can be used for a reduction of the capacity of the capacitor. With the same amount of stored energy a small capacity of the capacitor 400 is then sufficient for a reliable starting process.

A further increase of the amount of energy in the capacitor 400 can be obtained by a further increase of the charging voltage to more than 16 V in conventional electrical systems. A limitation to a charging voltage of 16 V has the advantage that this increase does not entail any further complications with other electrical components of the electrical system. Nowadays, all electrical and electronic components of a motor vehicle electrical system are designed for a maximum operating voltage of 16 V. The charging voltage of the capacitor 400 is therefore preferably oriented by the design of the electrical components of the electrical system and the voltage stability of the capacitor itself. In future electrical systems having a system voltage of 42 V the capacitor is chargeable to a significantly higher voltage, provided that a short-term voltage increase is withstood by the other electrical components without any problems.

Alternatively, with particularly high output voltages of the voltage transformer, any complication with other electrical system components can be excluded by disconnecting all load circuits or consumers, respectively, by means of the semiconductor switches 410, and a particularly safe starting process can be realized.

The charging of the capacitor takes place in time prior to the start of the starting process. For initiating the charging process of the capacitor 400 several triggers may be used. For example, the driver can start the charging if the ignition key is inserted or the ignition lock is brought into the position “ignition ON”. Alternatively, the charging process can be triggered by opening a vehicle door, whereby the opening of an optional vehicle door and the opening of the driver's vehicle door can be detected and used as trigger signal for the charging. If the vehicle door is used as trigger event for the start of the charging process, more time is available as compared to the detection of the ignition key position.

With the ignition key position “Start” the voltage transformer is switched off. The interrupter 320 remains open as long as the starting process continues. As soon as the internal combustion engine runs by itself the interrupter is 320 is closed and the electrical system is, again, set to a voltage of approximately 12.5 V.

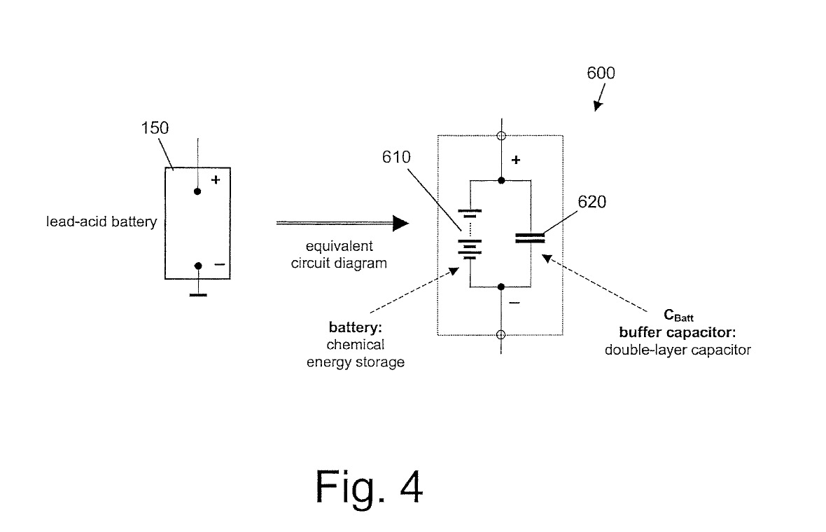

The capacitor 400 not only allows an improvement of the starting process, but can moreover assume the buffer operation of the conventional battery 150. An equivalent circuit diagram of a conventional battery 150 is shown in FIG. 4.

The equivalent circuit diagram 600 of battery 150 shows that the battery not only has the function of a chemical energy storage 610, but also the function of a buffer capacitor 620. This capacitor effect results from the interior setup of the lead-acid battery.

The capacitor effect of a conventional battery has previously been used to smooth the voltage fluctuations caused by the generator 120.

With a running motor vehicle engine, the generator 120 generates a three-phase current which is rectified by means of diodes. In today's motor vehicle electrical systems the battery 150 is physically mounted to be between the generator 120 and the consumers in the load circuits 412. Above all, a low pass is formed from the combination of the battery capacity C_{Batt} and the supply line resistance of the electrical connection line between the generator 120 and the battery 150 R_{Zul1}. The low pass effects a smoothing of the voltage fluctuations of the current generated by the generator.

According to the invention this function is assumed by the high-capacity capacitor 400.

While conventional electrical systems are designed such that high currents can flow on the electrical connection lines between the generator and the battery to compensate the voltage fluctuations, the function of storing and buffering energy is, according to the invention, assumed by separate modules in the motor vehicle electrical system. While the capacitor 400 is responsible for buffering voltage fluctuations, the battery 150 provides for the energy for the starting process. Thus, the battery can be mounted away from the generator and the power distributor in a simple manner, without requiring the conventional expenditure for an electrical line connection 240 with the battery. On the contrary: As was described by means of an example in connection with FIG. 2, the cross-sections can be reduced to significantly smaller values. By this, motor vehicle electrical systems become lighter and more inexpensive.

The buffer function is achieved with an arrangement in the order generator-battery-power distributor-consumer, in connection with the adjusting low-pass filter. The low pass is formed from the supply line resistance R_{Zul1} between the generator and the battery, on the one hand, and the capacity C_{Batt} of the battery, on the other hand. A smaller line cross-section moreover provides for a higher supply line resistance R_{Zul1} and thereby improves the low pass effect on the basis of the equation for the time constant Tau of the low pass:

Tau=R_{Zul1}·C_{Batt}

Summarizing, the new motor vehicle electrical system according to the invention has a number of advantages as compared to conventional electrical systems. The starter battery no longer assumes the starting function, is exposed to a smaller pulse and current load, has to satisfy only reduced requirements with respect to the low temperature behavior and may be a battery with a reduced storage capacity. By means of a voltage transformer the energy and, thus, the starting reliability can be increased. The lines have a smaller cross-section, so that cost and weight advantages are achieved, especially if the battery is mounted in the rear end of the motor vehicle.

1-12. (canceled)

13. A motor vehicle electrical system, comprising: a generator, a battery, a high-capacity capacitor and a power distributor for controllably supplying energy to individual load circuits of the motor vehicle, wherein
the generator, the battery and the high-capacity capacitor are connected in parallel, and
the electrical connection line between the battery and the power distributor has a cross-section of less than 10 mm² if the line is less than 2 m long (L_{Zul3}) while having a cross-section of less than 40 mm² if the line is more than 2 m long (L_{Zul3}).

14. A motor vehicle electrical system according to claim 13, wherein the high-capacity capacitor is mounted adjacent to the power distributor.

15. A motor vehicle electrical system according to claim 13, wherein the high-capacity capacitor is mounted inside the power distributor.

16. A motor vehicle electrical system according to claim 13, wherein the electrical connection line between the generator and the power distributor has a cross-section of less than 10 mm².

17. A motor vehicle electrical system according to claim 13, wherein the electrical connection line between the generator and the power distributor has a cross-section of approximately 5 mm².

18. A motor vehicle electrical system according to claim 13, wherein the electrical connection line between the generator and the power distributor has a line length (L_{Zul1}) of less than 2 m, preferably of less than 1.5 m.

19. A motor vehicle electrical system according claim 18, wherein the electrical connection line between the generator and the power distributor has a maximum line length (L_{Zul1}) of approximately 1 m.

20. A motor vehicle electrical system according to claim 13, wherein the electrical connection line between the battery and the power distributor has a maximum cross-section of approximately 5 mm² if the line is maximally approximately 2 m long (L_{Zul3}).

21. A motor vehicle electrical system according claim 20, wherein the battery and the power distributor are mounted in the engine compartment of the motor vehicle.

22. A motor vehicle electrical system according to claim 13, wherein the electrical connection line between the battery and the power distributor has a maximum cross-section of approximately 25 mm² if the line is maximally approximately 4 m long (L_{Zul3}).

23. A motor vehicle electrical system according claim 22, wherein the battery is mounted in the rear end and the power distributor in the engine compartment of the motor vehicle.

24. A motor vehicle electrical system according to claim 13, wherein the high-capacity capacitor is connected between the generator and the power distributor.
